(19) United States
(12) Patent Application Publication
(10) Pub. No.: US 2006/0293870 A1
(43) Pub. Date: Dec. 28, 2006

(54) Method and system for tracking quality events

(76) Inventors: Andrew T. Rassi, Morton, IL (US); Jeremy D. Deml, Yorkville, IL (US); Douglas P. Fauth, Peoria, IL (US); Dennis D. Hammerschmidt, Decatur, IL (US); Alberto P. Leone, Peoria, IL (US); Lawrence J. Stokowski, Tremont, IL (US)

Correspondence Address: CATERPILLAR INC.;100 N.E. ADAMS STREET, PATENT DEPT., PEORIA, IL, 616296490, US

(21) Appl. No.: 11/325,996

(22) Filed: Jan. 5, 2006

Related U.S. Application Data
(60) Provisional application No. 60/689,513, filed on Jun. 10, 2005.

(51) Int. Cl. G06F 11/00; G06F 15/00

(52) U.S. Cl. 702/188

(57) ABSTRACT

A method and system for tracking events during a multiple process operation. The method and system includes monitoring each of a plurality of processes as they occur, determining the existence of an event, and inputting the event into a master database as the event is determined.

This application claims the benefit of prior provisional patent application Serial No. 60/689,513 filed Jun. 10, 2005.

### TECHNICAL FIELD

This invention relates generally to a method and system for tracking events during a multiple process operation and, more particularly, to a method and system for tracking defects as they are found during a multiple process operation.

### BACKGROUND

The possibilities for the introduction of defects may exist at many steps and locations during an operation that includes multiple processes. For example, an assembly line at a manufacturing facility may be prone to the introduction of defects at several locations on the line.

A defect that appears in one portion of the operation may have an adverse effect on subsequent processes, and ultimately may have an adverse effect on the final product. Furthermore, an early defect may be hidden by later processes. For example, a problem with a bolt installed during an initial step in an assembly line may not be found later on, due to additional steps that might cover the defective bolt. The problem may be compounded if the defect is a recurring one, such as a batch of bolts being installed with problems on each of a batch of products.

Attempts have been made to monitor and track defects during multiple process operations. For example, many manufacturing facilities employ the use of inspectors, quality control technicians, and the like, to periodically test and inspect sample products at various stages of completion. Although these procedures have met with limited success, they do not offer the advantages that constant monitoring along the entire process line would offer.

Other methods used include empowering persons working on the line to attach an event card, i.e., a defect card, to the product as events are found. The cards are then input into a database by one person at the end of the line. Although methods such as this enlist the aid of additional persons to monitor and track defects, this is still not a real-time procedure; that is, the events are not input until the product reaches the end of the line. Furthermore, the information placed on the cards may not use consistent descriptive language, thus making it difficult to recognize repeat defects.

The present invention is directed to overcoming one or more of the problems as set forth above.

### SUMMARY OF THE INVENTION

In one aspect of the present invention a method for tracking events during a multiple process operation is disclosed. The method includes the steps of monitoring each of a plurality of processes as they occur, determining the existence of an event, and inputting the event into a master database as the event is determined.

In another aspect of the present invention a system for tracking events during a multiple process operation is disclosed. The system includes a computer, a master database located in the computer, a plurality of terminals, each located at a process location, and means, at each terminal, for inputting the existence of an event at the process location in which determination of the event occurred.

### BRIEF DESCRIPTION OF THE DRAWINGS

FIG. 1 is a block diagram illustrating an embodiment of the present invention;

FIG. 2 is a diagrammatic illustration of a portion of a display as embodied with the present invention; and

FIG. 3 is a flow diagram illustrating a method of the present invention.

### DETAILED DESCRIPTION

Referring to the drawings, a method and system 100 for tracking events during a multiple process operation is shown. Events may be characterized as quality events, and may include such events as quality defects. A multiple process operation may include any of several types of operations, for example manufacturing, assembly, shipping, and the like. For illustrative purposes, the present invention will be described in the context of an assembly line, such as may be found at a manufacturing facility.

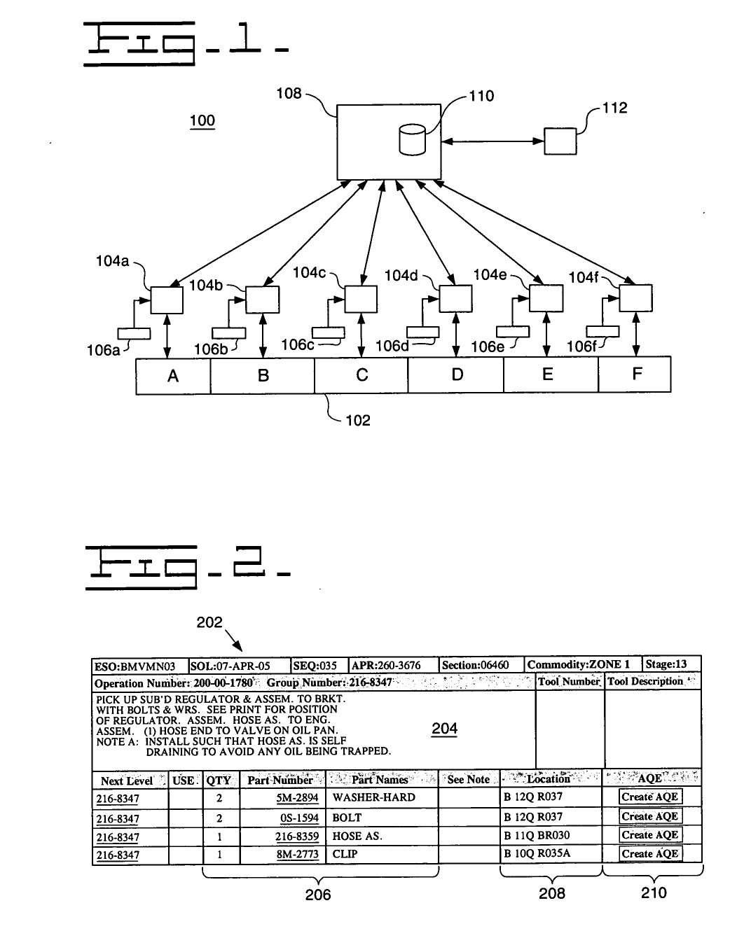

FIG. 1 depicts, in block diagram form, a process operation 102 having multiple processes, shown as blocks A-F. For example, an assembly line may begin at block A and continue through block F, each block having a specific assembly process assigned.

At each block A-F, a terminal 104 is shown. The terminal 104 may be a computer terminal. The terminal 104 may also be a standard personal computer, such as a client PC. A corresponding terminal 104, labeled 104a-f, is shown at each individual block A-F in the process operation 102. However, each block may not require a dedicated terminal 104. Thus, any number of terminals 104, located at any number of blocks, may be used as needed.

Each terminal 104 may have typical components associated with computer terminals, such as inputs, outputs, displays, and the like. Specifically, each terminal 104a-f is shown having an associated means 106a-f for inputting. The means 106 for inputting may include any suitable device, such as a keyboard, mouse, light pen, scanner, or any combination thereof.

Typically, an assembly line, such as illustrated as the process operation 102 of FIG. 1, will include workers stationed at specific blocks, assigned to perform specific tasks. For example, a worker at block A may be assigned to perform a first assembly operation, a worker at block B may perform a second assembly operation, and so forth until a worker at block F performs a last assembly operation. However, it is noted that any one or more of the assembly steps may be automated and may or may not have a worker assigned to monitor the automated process.

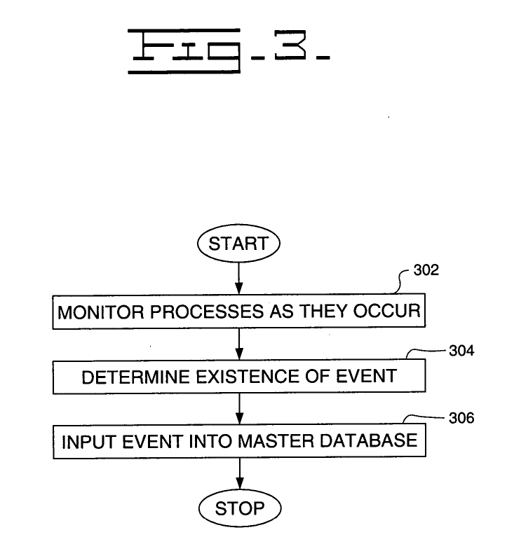

Each terminal 104 may be configured to provide instructions to a corresponding worker regarding the assembly work at the relevant block. For example, referring to FIG. 2, a display 202 at the terminal 104 may include process instructions 204, a list of process parts 206, information relevant to the process location 208, and other such useful information. The information may be updated as needed, for example if the instructions or parts lists must be changed. Typically, each terminal 104a-f will be configured to display instructions relevant to the corresponding block A-F only.

A computer 108 may be configured to interconnect with each of the terminals 104. The computer 108 may be a server that communicates with the terminals 104a-f selectively and as needed. The computer 108 may be located at any desired location and may interconnect with the terminals 104 by way of wired or wireless technology. Typically, the computer 108 is configured to receive information from and deliver information to each of the terminals 104. The computer 108 may include a master database 110 that is accessed and shared by all terminals 104. Alternatively, the master database 110 may be located at another computer, e.g., server, and accessed by the terminals 104 by way of the computer 108. The computer 108 may also be configured to link to an external computer 112, at the same or a remote location. The external computer 112, which may include multiple computers, may provide such functions as reporting, editing, analysis, and the like.

The terminals 104 and external computer 112 may be configured to communicate with the computer 108 by way of a web browser, a dedicated network, hard-wired connections, and the like, or any combination thereof.

### INDUSTRIAL APPLICABILITY

Operation of the present invention may be described with reference to the simplified flow diagram of FIG. 3, with continued reference to FIGS. 1 and 2.

In a first control block 302, the processes are monitored as they occur. For example, in each block A-F of process operation 102, e.g., assembly line, a worker may monitor a respective process in a corresponding block, either as the work is being performed manually or by automation. The monitoring is thus being performed in real time, i.e., as the process occurs.

In a second control block 304, the existence of an event may be determined. For example, it may be determined that an event has occurred that correlates to a defect. As a more specific example, it may be determined by a worker at block D that one or more bolts on a specific component that have been installed in a prior block are not tightened sufficiently. As another example, it may be determined by a worker at block E that a previously installed component has a crack in it.

In a third control block 306, the event is input into the master database 1 10, preferably by way of a corresponding terminal 104a-f and associated means 106a-f for inputting. Continuing with the above specific examples, the worker at block D may enter the occurrence of the insufficiently tightened bolts by way of terminal 104d and means 106d for inputting, e.g., a keyboard. In like manner, the worker at block E may enter the occurrence of the cracked component by way of terminal 104e and means 106e for inputting. The master database 110 may compile the input information for reporting and other purposes, as described below.

FIG. 2 illustrates an event field 210, which has a selection denoted “Create AQE” for each of a variety of assembly parts and/or steps. AQE (Assembly Quality Events) is a descriptive acronym for an assembly line application of the present invention. Other terms may be used as appropriate for other applications. The display 202 shown in FIG. 2 uses the AQE event fields 210 as a convenient entry field for a worker to enter event information. The worker may be further prompted with selection buttons to key in for additional entry of information, may be prompted to enter text to further describe the event, or may be prompted by a combination of the above and any other suitable entry means. Typically, the entry fields for the worker to enter event information are designed for consistent ease of use, yet are designed to gather as much useful information as possible.

The master database 110 in the computer 108 receives the event information from the terminals 104, and stores the information for reporting purposes. For example, a person may access reports from the master database 110 by way of an external computer 112. A person may also access reports from any of the terminals 104 located at the process operation 102. The computer 108 may organize the data so that key defects are singled out for initial targeting, e.g., a top 5 list of defects may be focused on.

The computer 108 may analyze the information received by the master database 110 and determine a repeat occurrence of an event. For example, a cracked component may be found to be occurring repeatedly, thus indicating a possible problem with assembly of the component, a supplied part, or the component itself. The determination of a repeat occurrence of a defect may be set to trigger when a certain number of similar events occur within a certain time frame. For example, if 5 events occur within a 2 month period.

The computer 108 may be configured to send out notices via email to specific destinations, such as a supervisor, management, quality control, and the like. The email notices may be set to trigger from a number of circumstances, for example the above-described repeat occurrences, certain significant events, a time schedule, e.g., weekly or monthly, and the like. The specific information contained in an email notice may be selected based on the target email recipient, the type of message, the importance of the message, and such.

The computer 108 may be set up to analyze the event information to determine a likely source for the defect. For example, if an event is entered from block D that some bolts are not tightened sufficiently, the computer 108 may determine that the bolts were installed at block C, and that the defect most likely originated there. The computer 108 may then create an email notice, and may send it to the terminal 104c at block C, as well as to a supervisor's computer.

The computer 108 may analyze the event and determine that a process is being performed that is not using the most recent version of process instructions. As an example, in an assembly line, certain instructions at one or more blocks may be upgraded for various reasons. A specific example might be an upgrade of bolt tightening requirements at block C. It may be determined from an event entry from block D, relating to insufficiently tightened bolts, that the worker at block C is still tightening bolts according to an older version of instructions. The computer 108 may then be set up to send out appropriate email notices to resolve the issue.

The computer 108 may be configured to link certain defects back to one or more suppliers as possible sources for the defect. Information such as this might allow management to determine a supplier issue that requires addressing and resolution. As an alternative, the computer 108 may be configured to send out email notices to suppliers themselves if supplier issues are suspected, thus providing suppliers with the opportunity to resolve defects soon after they are identified.

The present invention provides a method and system to identify and address quality events, such as quality defects, as they are discovered. The observations of various workers at points along a process operation 102 may be monitored and recorded during implementation of the processes, thus allowing quick and efficient tracking of problem areas. The defects found are typically those that may be visually observed by a number of persons during real time operations, such as on an assembly line during the assembly processes. Additional examples of observed defects in an assembly line might include paint defects, missing parts, leaks, mismatches, damaged bolts, spalled and pitted surfaces, and the like.

Other aspects can be obtained from a study of the drawings, the disclosure, and the appended claims.

What is claimed is:

1. A method for tracking events during a multiple process operation, comprising the steps of:
monitoring each of a plurality of processes as they occur;
determining the existence of an event; and
inputting the event into a master database as the event is determined.

2. A method, as set forth in claim 1, wherein determining the existence of an event includes the step of determining the existence of a quality event.

3. A method, as set forth in claim 2, wherein determining the existence of a quality event includes the step of determining the existence of a defect.

4. A method, as set forth in claim 1, further including the steps of:
receiving inputs of events; and
determining a probable source of occurrence of each event.

5. A method, as set forth in claim 1, further including the steps of:
receiving inputs of events; and
determining a repeat occurrence of like events.

6. A method, as set forth in claim 5, wherein determining a repeat occurrence of like events includes the step of determining a repeat occurrence of like events as a function of like events occurring within a designated time period.

7. A method, as set forth in claim 6, further including the step of determining a probable source of occurrence of the repeat events.

8. A method, as set forth in claim 7, further including the step of determining a modification to a process in response to the repeat events.

9. A method, as set forth in claim 1, further including the steps of:
receiving inputs of events; and
generating reports of the events occurring.

10. A method, as set forth in claim 1, further including the steps of:
receiving inputs of events; and
sending notices to designated recipients with regard to select events.

11. A system for tracking events during a multiple process operation, comprising:
a computer;
a master database located in the computer;
a plurality of terminals, each located at a process location; and
means, at each terminal, for inputting the existence of an event at the process location in which determination of the event occurred.

12. A system, as set forth in claim 1 1, wherein at least one terminal includes a display.

13. A system, as set forth in claim 12, wherein the display is configured to indicate at least one of a set of process instructions, a list of process parts, and information related to the process location.

14. A system, as set forth in claim 12, wherein the display is configured to indicate an event field for displaying information delivered by the means for inputting.

15. A method for tracking events during a multiple process operation, comprising the steps of:
monitoring each of a plurality of processes as they occur;
inputting to a terminal located at a process location the existence of an event at the time the event is determined; and
delivering the event determination to a master database located in a computer.

16. A method, as set forth in claim 15, further including the step of determining a probable source of occurrence of the event in response to the master database receiving the event determination.
